(19) United States
(12) Patent Application Publication
(10) Pub. No.: US 2016/0339328 A1
(43) Pub. Date: Nov. 24, 2016

(54) LONGITUDINALLY AND LATERALLY SELF-BALANCED ELECTRIC UNICYCLE

(71) Applicants: Jannick Jacques SIMERAY, Argenteuil (FR); Marc Daniel SIMERAY, Argenteuil (FR)

(72) Inventors: Jannick Jacques SIMERAY, Argenteuil (FR); Marc Daniel SIMERAY, Argenteuil (FR)

(21) Appl. No.: 15/112,558

(22) PCT Filed: Jan. 20, 2015
(86) PCT No.: PCT/IB2015/000613

§ 371 Date: Jul. 19, 2016

Related U.S. Application Data
(60) Provisional application No. 61/929,137, filed on Jan. 20, 2014.

(51) Int. Cl. A63C 17/00; A63C 17/12; B62K 1/00; B62K 3/00; B60L 11/16; B60L 11/18; A63C 17/01; A63C 17/26

(52) U.S. Cl. CPC A63C 17/0093; A63C 17/014; A63C 17/12; A63C 17/26; B62K 3/007; B60L 11/16; B60L 11/1877; B60L 11/1809; B62K 1/00; B60L 2200/16; B60L 2260/34; B62K 2204/00

(57) ABSTRACT

Self balanced electric wheel optimized for dynamic stability suspension and damping functions in use, compactness and low weight when carried short learning step, low cost and liability.

### BACKGROUND OF THE INVENTION

The user of public transportation must deal with a variety of constraints: his or her hands are full with objects to be carried, briefcase, school bags, errand items, etc. Public transportation is cramped and overcrowded; the sidewalk is busy, the stairs are narrow and steep, the public thoroughfare is governed by strict rules. After arriving at his or her destination, he or she must deal with social constraints whether at work or at school, and it can be difficult to change shoes and clothes. In addition, he or she must be able to use the aid in his or her usual attire.

It is also impossible to travel on the subway or train every day with a bicycle. It is difficult to go down stairs in roller skates; electric skateboarding are prohibited on public thoroughfares, such as a scooter; and even a vehicle such as the Segway®, designed for short-range city trips, turns out to be cumbersome on the sidewalk and not transportable on the subway and bus.

The state of the art comprises the Segway®, a platform aid comprising two wheels, rechargeable batteries, a central inertial stabilization device, and a handlebar integrated with the platform. This platform is not sufficiently compact to move along without difficulty on the sidewalk. It is too slow to move along on the road and, finally, its weight, in the order of 30 kg, prevents it from access to public transportation.

Document DE 100 27 466 describes a unicycle onto which the pedestrian climbs on two footrests, rests his or her hands on a handle that transmits the longitudinal inclination to the frame of the unicycle. An electronic device reads the longitudinal inclination of the unicycle by means of an electronic inclinometer and monitors the position of the wheel to maintain the balance of the user's means his center of gravity over the stand in order to prevent him or her from falling in accordance with an inverse tilt effect. The device moves forward as soon as the user inclines the handle forward. The wheel exhibits a square section so that the user is stable laterally. Because of this, path is guided within the longitudinal axis. The means for turning is not described, it is understood that it is necessary to briefly stand on the ground in order to convey lateral torque. Of course, turning the handle cannot ensure rotation because the footrests and the shaft are integrated via the fork.

Document DE 100 27 466 thus does not meet the criteria of the invention to the extent that it requires the user to hold the handle with at least one hand, and what is more it does not permit agile and harmonious steering to the extent that only longitudinal travel is provided for. Finally, the electronic device controlling the motor is served by an inclinometer, which is a different solution than that adopted by the invention.

U.S. Pat. No. 6,302,230, of Kamen represents several embodiments of balance unicycles, not optimized in order to be easily carried which imposes compact and lightness and it not described how to climb on it since the wheel is exposed and turning and its side may in consequence not transmit any lateral torque on the user's legs.

U.S. Pat. No. 8,616,313 Simeray of December 2013 under priority of November 2005 describes an:

‘Autonomous electric mobile aid intended to transport a city dweller comprising: a single wheel, an electric motor, a battery, a fork, and two footrests characterized in that the ergonomics and driving of it are intuitive and do not require the use of the hands by means of:
two combined supports secured to the fork on either side of the wheel that are each configured to operate as a lever to convey stress and torque of the wheel response to a leg of the user;
the motor being of the type that keeps the wheel directly under the center of gravity of the average city dweller;
a driving electronics of the motor controlled linearly by a balance sensor on the fork;

wherein lateral steering is agile by means of the single wheel having a tread that is approximately round in shape in a plane parallel to an axis of rotation of the single wheel; and wherein it is compact when carried by the city dweller by means of the two footrests being foldable.’

This USA patent also describes and protects:
Any balanced wheel with combined supports configured so as to tightly holding the leg and the calf or with combined support configured so as not tightly holding the leg and the calf, according to the preference of the dweller to unfold or fold down the combined supports or guides during use.
Any balanced wheel having at least one footrest longer than the lateral supports in a direction perpendicular to the plan of the wheel, even if the support is an unfolded guide in the FIG. 6 disclosing a footrest around 30% longer than the guide. This is illustrated by the dashed lines added FIG. 20 of the present document on the copy of the original publication.
Any balanced wheel operating legs supports configured as not to substantially encircle the leg of the user as it is represented in FIG. 1, FIG. 2, and also represented in FIG. 6 and reported FIG. 20 of the present document because:
   Tightly holding the leg and the calf does not mean ‘significantly encircling the leg’.
   Lateral supports are not described as ‘significantly encircling the legs’ of the user
   The legs supports are not configured to encircle the leg in FIGS. 1 and 2 but are in a U shape allowing the user to escape easily and are represented in the folded and unfolded positions.

There is no leg represented in FIG. 6, and in consequence there is no representation of a leg substantially encircled by a leg guide.

If the guide represented in FIG. 6 encircled the leg, it would be technically and anatomically impossible to insert a leg due to the narrow opening represented.

The man skilled in the art would then have immediately understood that inserting a leg in a guide like the one represented in FIG. 6 is impossible because even handcuffs need a large opening for imprisoning hands.

He would have also understood that FIG. 6 illustrates the concept of a guide transmitting torque and stress and is not a tridimensional drawing for a servile execution.

He would have built a guide or a lateral support in the essence of the invention and in accordance with the general specifications of a balanced wheel such to consider the comfort, security, and the level of torque and stress to transfer according to the power and speed of the wheel and its version, sport or commuter, without the need of an inventive step.

He would have adapted its size, shape, material, friction, softness, and elasticity. Connection with the footrest by a rod would have been optional. All said specifications are therefore respected without any inventive step.

It is therefore believable that the man skilled in the art would have reduced the guides to a low profile shape of U for a low power and low speed wheel transmitting low torque and low stress to the user's legs and increased such branches of the U for the guides for a wheel dedicated to competition and/or acrobatic figures generating high torque and high stress to the user's legs.

Inventist and its owner Shane Chen concluded with the present applicant Simeray in March 2011 a license of Simeray's 2005 invention with an option of exclusivity worldwide and in consideration of royalties and operated under the Trade Mark®Solowheel the Simeray invention since 2012.

Inventist has distributed a wheel manufactured in China, exhibiting a very low top speed and a low power generating almost no stress and no torque on the user's leg, except when the user climbs on it and generates with his leg and foot in a significant lateral torque and stress.

As license operator having an average skill in his art, Shane Chen has adapted the size and the shape of the guide to the very low level of longitudinal torque and of stress to convey to the user's leg, and designed guides with a U shape in soft material having very short branches, not foldable.

During the negotiation of the license, and without disclosing it to Simeray, Shane Chen has filed the utility patent application US 20110220427 of March 2011 claiming;

‘A powered unicycle device, comprising: a single wheel rotatably coupled to a frame; a motor which drives said wheel; an electronic fore-and-aft balance control system which controls said motor; a foot platform or platforms coupled to said frame; and leg contact surfaces on said frame, made of a yielding material and protruding outward from the main body of said frame’.

This application rejected 6 times in consideration of Simeray's prior art and lack of inventiveness finally became a patent in august 2014 U.S. Pat. No. 8,807,250 allowing:

A powered unicycle device, comprising:
a single wheel having an axis of rotation and defining a central vertical plane in the line of direction of travel that is rotatably coupled to a seat-less frame;
a motor which drives the wheel;
an electronic fore-and-aft balance control system which controls said motor;
first and second foot platforms coupled to the frame and each having a standing surface that is below the axis of rotation of the wheel;
a first leg contact surface that in its entirety extends substantially longitudinally in the line of travel of the device and is configured to be readily contactable by the side of a user's leg, at or below the knee, when that user is standing on the first foot platform; and
a second leg contact surface that in its entirety extends substantially longitudinally in the line of travel of the device and is configured to be readily contactable by the side of a user's leg, at or below the knee, when that user is standing on the second foot platform;

wherein the first and second foot platforms extend in a direction perpendicular to the central vertical plane of the wheel further than the contact surfaces extend perpendicular to the central vertical plane, and further wherein the leg contact surfaces are configured so as to not substantially encircle a user's leg.

The present applicant Simeray doesn't understand this new previous art and especially:
Why and how Mr Shane Chen operator of a license with option of exclusivity, beneficiary of the transfer of know how necessary for operating the invention, exhibiting no inventive step by adapting the Simeray's invention to a slow balanced wheel, has been granted a utility patent for demonstrating skill as operator of a license.
Why the exclusive right to operate his invention in USA granted by the USPTO in December 2013 to Simeray has been almost equally granted to his licensee Shane Chen of 6 months later for a utility patent application filed 6 years after Simeray's priority.
Why Simeray's right to operate his invention without damageable interference is now restricted to the combination of handcuff like leg clips with 2 very short footrests that any skilled man wouldn't have considered knowing of the reasonable configuration of appropriately sized footrests and leg clips as show in FIG. 2 of Simeray's patent.
Why the concept of leg clips that ‘encircle’ the legs has been associated with Simeray's patent when there is no mention of it in the description or claims.
Why Shane Chen's patent application was rejected 6 times for obvious lack of inventiveness and on which new argument it has been finally granted.

Inventist concluded a license with an option of exclusivity worldwide of Simeray's patent and taken a design called Solowheel to market for 3 years in consideration of paying royalty when Simeray's patent is granted.

When the Simeray patent was granted in December 2013, Inventist breached the license agreement with by not paying the royalties due. The license of Inventist has been terminated in March 2014 by Simeray because of the breach.

The applicant not only unable to understand the prior art, its chronology and its meaning, respectfully apologizes for being also unable to identify who owns said previous art.

The present invention discloses the several improvements all necessary for the dissemination of the balanced wheel in the mass market.

Those improvements fix:

The weight, its width, its static and dynamical balance, the learning curve, the cost, the liability.

The present invention solves simultaneously these issues by inventive steps in a configuration remaining outside of the scope of the claims granted seemingly consecutively to Simeray and to Shane Chen in order that Simeray may have the privilege to operate his invention freely.

The current electric unicycles on the market fall inside the original Simeray patent and are designed with most of the weight above their center.

The power required to balance the user increases with the level of the center of gravity of the unicycle.

When the user steps down from the wheel, it needs lateral stabilization either from one leg on the side of the wheel (requiring torque against the wheel) with its foot on the pedal and one foot on the ground or held up by hand to keep if from falling down and becoming dirty.

With the electric unicycles on the market, there is a significant learning curve due to a lateral instability caused by a large wheel and no freedom of motion for the user's legs. This loss of freedom of motion is due to the size of the electric unicycle and how far apart it spreads the user's legs. This problem can be solved by having a design narrow enough that allows the users legs to move freely (as shown in the 2005 Simeray patent when the leg guides are in the folded position). This freedom of motion would allow the user to tilt the wheel laterally and in effect shift the contact point laterally allowing for better control.

However the user still needs to transmit a lateral torque and stress on the wheels side with his leg when he climbs on it.

A safety issue relates to a lack of headlights, tail lights, and running lights. The headlight is especially necessary to prevent the user from being surprised by surface irregularities. This is even more critical than for a bicycle, having a natural longitudinal stability. By highlighting through illumination obstacles and surface irregularities, the user may anticipate and react in a way to avoid falling.

Another safety issue is how a pedestrian may be surprised by the silent or fast electric unicycle rider. A sound warning could be used to prevent collisions.

Another safety issue is noted when the user steps down in an emergency or unpredictable situation and the sudden longitudinal misbalance causes the device to drive the wheel at full power spinning the frame into the user's leg.

A detection of the lateral misbalance should cause the motor to brake.

Another safety issue is related to the ground clearance necessary when the turns and leans. If the footrest bumps the floor during a high speed turn then the user twists and falls painfully. The balanced wheel must be able to lean around 30° before a footrest touches the ground.

Another security issue is related to the liability.

Regulations limit up the speed on the sidewalks and limits down the speed on the street. The dweller must adapt his driving to the existing regulation and assume the responsibility of any accident happening in breach of the regulation. The public information related to the current speed of the electric transportation device could contribute to attribute the responsibilities.

### SUMMARY OF THE INVENTION

The invention is designed as a motorized electric aid that helps the city dweller in his or her pedestrian trips and that ideally remains compatible with all of the constraints listed above.

In a preferred embodiment, the invention abides by the following criteria: the aided pedestrian has the size of a normal pedestrian; moves along on the sidewalk at a pedestrian speed up to approximately 7 km/h and moves along on the road at a speed less than 30 km/h. The pedestrian has the agility of a normal pedestrian or skater and moves along without effort with the use of both hands and is able to wear his or her usual clothing and shoes.

The aid is compact, portable, and light, in for example a backpack, it weighs less than 5 kg has a volume less than 40 cm in diameter by less than 6 cm in thickness and can be recharged via a household electric socket or by another equivalent means. It offers a range of approximately one hour or 15 km.

The present invention by inventive step solves the dilemma of how to keep sufficient ground clearance under the pedals, a tight profile of the wheel in and after use, and how to increase its static, dynamic, lateral, and longitudinal stability by placing the heavy components under the wheels center. The wheels on the market are too large especially at the ankle level and there would be no improvement by lowering the batteries at the ankle level and enlarging the profile even more.

The inventive step include a complete reconstruction of the balanced wheel in which most of the weight is located in the foot rest, the wheel is a tight light and flexible hub-less wheel and the unique foot rest or the combined foot rests crosses the wheel's main plan, what is totally new and operable.

This present invention further describes:
The static longitudinal and lateral stability of the motorized wheel standing up by itself before use and in use
   Due to a Center of Gravity (CG) significantly lower than its axe.
   Due to a center a curvature of the tire over the center of gravity.
   Due to its tight profile of the wheels casing, its large footrest allowing enough room between the legs in order to lean it between the legs and to move the contact point on the floor laterally even at no speed.
The dynamic stability of the motorized wheel:

The longitudinal stability is improved through
a lighter wheel, its empty center, (around 600 g, effectively ten time less than the current wheels on the market) allowing efficient short response time longitudinal adjustments.
a high power to weight ratio of the motorization system allowing short response time of the stabilization.
a Gravity Center significantly lower than its axe and near the floor reducing the power needed for a short time reaction almost independent from the weight of the user, but directly proportional to the powered unicycle's weight relative to the center of gravity and relative to the floor.

The lateral stability improved through
the comparatively high inertial momentum of the rim and tire compared to the weight of the rest of the device.
This gyroscopic effect combined with the freedom of motion between the device and the user's legs allows for a greater lateral stability.
at least 2 mechanical connections and 2 electrical connections to a combined or removable gyroscope composed of a housing embedding a flywheel powered by an electrical motor, turning around an axe parallel to the wheel's axes in the same or the opposite direction according to the balanced wheel's speed for increasing the precession of the tire at low speed and reducing it effect at high speed.
An airless tire made of a rubber like material exposing to the floor a circular contact surface generating almost no friction torque when the user orients the wheel at no or low speed for keeping balanced, thanks to a curvature center significantly over the center of gravity CG.
Its weight and encumbrance is reduced when it is carried by the user, thanks to
   a compact light powerful and efficient brushless motor, connected to a speed reducer in order to operate the motor at its efficient speed.
   an hub-less wheel, a tight profile, an empty space in the center of the wheel casing being the placement of the footrest when the device is not is use.
   a light battery solution combining high power density battery and high energy density battery.
   A footrest or combined foot-rests being the container of the main heavy and cumbersome components.
   a photoelectric charger of the battery covering its surface.
The friendly learning and the ergonomics, the lateral torque transmitted to the legs when climbing on suppressed or dramatically reduced due to:
   The said tighter profile reducing the lever of the foot on the foot-rest.
   A lateral support on the ground, retractable in option, ensuring with the wheel a natural lateral stability and suppressing any lever on the leg for stepping up and down like if the wheel were a stable step.
The large platform and tire curvature allow for a higher stability in use and before and after use.
The dynamic stability resulting from
   the optimized gyroscopic momentum of the wheel in combination with the freedom of motion to tilt the wheel laterally.
the combination of an electrically powered removable gyroscope and with the freedom of motion to tilt the wheel laterally.
The comfort of the user improved due to:
   The rolling vibrations damped thanks to the suspension of the footrest, rolling inside the rim of a flexible wheel, having a tire or rim composed of an elastic material.
   A mechanical transmission compatible with such flexibility of the rim.
   Enough room for the ankles due to the empty space in the center of the wheel.
   A foldable seat supporting the user when tired and converting the said self balanced wheel into a electric self balanced unicycle with a reasonably comfortable seat, becoming fully a stable seat due to the lateral supports unfolded when the wheel is static and or the power switched off.
The security of the user and the conformity to the regulations due to
   An illumination of the path in front of the wheel by a white light and a warning behind by a red light, whenever the wheel has no identified front or back side.
   An automatic switch off of the motors due to a lateral balance sensor turning the motor driver off when it falls on its side.
   A source of sound warning, for example a music player with a volume substantially proportional to the speed in order to alert the pedestrians.
   A source of sound warnings for low battery and for when the user leans beyond the wheels maximum power output.
   A vibration generated by a motor under the users feet warning the user for the same purposes.
The balanced wheel's low center of gravity achieved through
   A foot rest being a container containing either the batteries, motor, electronic balance system, or any combination of said components.
   This footrest could also be structured in a way to be part to the wheel casing.
   This footrest could also be secured to the to the wheel casing.
   This footrest could also be an independent part of the wheel casing.
The liability and the safety of the user is improved due to a color pattern and a color code light informing the public about the current speed range of the wheel, in combination with a way to change the color of the balanced wheel or the color of its illumination in accordance with the current speed so that the witness in the case of an accident may report the speed range of the user by only reporting the electric vehicle's color and in consequence contribute to identify who is responsible.
A design with removable battery packs allowing the user to optimize its wheel's weight according to the autonomy desired.
A charger for recharging the batteries connectable to the domestic power having the shape of a battery pack for embedding in the wheel's platform despite of a battery pack.
A photoelectric charger of the battery covering at least one foot-rest connected to a step up voltage elevator for a permanent charge of the battery when expose to the sun.
One Unique footrest in order
   to allow the user to ride frontward, backward, and laterally in a surf position

### BRIEF DESCRIPTION OF THE DRAWINGS

Preferred and alternative examples of the present invention are described in detail below with reference to the following drawings:

FIG. 1 illustrates a nonexclusive embodiment of the present invention;

FIG. 2 illustrates a nonexclusive embodiment of the motor fixation of the footrests and transmission

FIG. 3 illustrates a nonexclusive embodiment of the footrests including the batteries

FIG. 4 illustrates a nonexclusive embodiment of the bumpers for suspending the footrests.

FIG. 5 illustrates a nonexclusive embodiment of one unique footrest inserted inside the wheel for carrying.

FIG. 6 illustrates a nonexclusive embodiment of the unique footrest inserted on the frame of the wheel for riding.

FIG. 7 illustrates a non exclusive embodiment of the motors batteries electronic and transmission included in the said unique footrest.

FIG. 8 illustrates a non exclusive embodiment of the deformation of the hub-less flexible wheel and its guide submitted to the user's weight.

FIG. 9 illustrates a non exclusive embodiment of the circuitry of the lighting.

FIG. 10 illustrates a non exclusive embodiment of 2 additional stands ensuring the lateral stability of the user at no or low speed thanks to an actuator unfolding them.

FIG. 11 illustrates optional parts on the guide.

FIG. 12 illustrates those parts assembled into a seat when unfolded.

FIG. 13 illustrates the 3 main interactions of the dweller with the balanced wheel.

FIG. 14 illustrates the respective position of the gravity center of the wheel in use.

FIG. 15 illustrates the removable battery packs, the removable charger, the motor for warning by vibration under the user's foot, the colored light for displaying the speed range.

FIG. 16 illustrates the mechanical and electrical connection of a removable housing embedding a fly wheel and a motor.

FIG. 17 illustrates the difference of shape of the interface between the floor and a air tire and the floor and the airless tire.

FIG. 18 illustrates an electrically balanced wheel without wheel's casing transmitting directly the lateral stress and torque of the wheel to a combined protection secured on the user's leg.

FIG. 19 illustrates an airless tire and rim which main deformation contributing actively to the longitudinal stability of the user.

FIG. 20 is a reproduction of Simeray's original patent with dashed annotations.

### DRAWINGS LISTING TO THE REFERENCES

| | |
|---|---|
| 2 Footrests | 14 |
| Brushless motor | 16 |
| Electronic Motor driver | 17 |
| Tires | 12 |
| Flexible rim | 13 |
| Guiding - ring | 15 |
| Tube axe | 21 |
| Motor's axe | 23 |
| 90° Gear reducer | 24 |
| Rollers | 25 |
| Rechargeable batteries | 36 |
| Batteries compartment cover | 32 |
| Walls for structure | 35 |
| Foot-rest tubular connection | 33 |
| Bumpers | 34 |
| Casing for electronic | 26 |
| Axis of the guide support | 43 |
| Soft and frictional surface | 45 |
| Guide support | 42 |
| Unique footrest | 55 |
| Handle | 54 |
| Direct reducer and gear | 53 |
| Electronic System | 71 |
| Roller's shaft | 72 |
| High Energy density battery | 73 |
| High power density battery | 74 |
| Illumination led | 80 |
| Warning led | 81 |
| Lateral balance leg | 110 |
| Lateral balance wheel | 112 |
| Actuator | 113 |
| Loudspeaker & music player | 75 |
| Speed detector and driver | 76 |
| 2 axis balance sensor | 77 |
| Opening in guide | 78 |
| Foldable part of guide | 121 |
| Foldable part of guide | 122 |
| Removable handle and seat | 123 |
| Hinge | 124 |
| Surf position | A |
| Frontward backward riding | B |
| Carrying position | C |
| Gravity center | CG |
| Lateral curvature center | CC1 |
| Longitudinal curvature center | CC2 |
| Removable battery pack | 151 |
| Removable domestic charger | 152 |
| Speed range color display LED | 153 |
| Gyro Locking holes & connectors | 154 |
| Warning vibration motor | 155 |
| Removable Gyroscope | 161 |
| Flywheel of the Gyroscope | 162 |
| Casing of the Gyroscope | 163 |
| Electric motor of the Gyroscope | 164 |
| Bearing of the gyroscope | 165 |
| Mechanical & electrical connection | 166 |
| Normal Air tire | 171 |
| Interface of airless tire | S1 |
| Interface of air tire | S2 |
| Leg protection | 181 |
| Roller | 182 |
| Rim with gear | 183 |
| Airless rim with spiral spokes | 191 |

### DETAILED DESCRIPTION OF THE PREFERRED EMBODIMENT

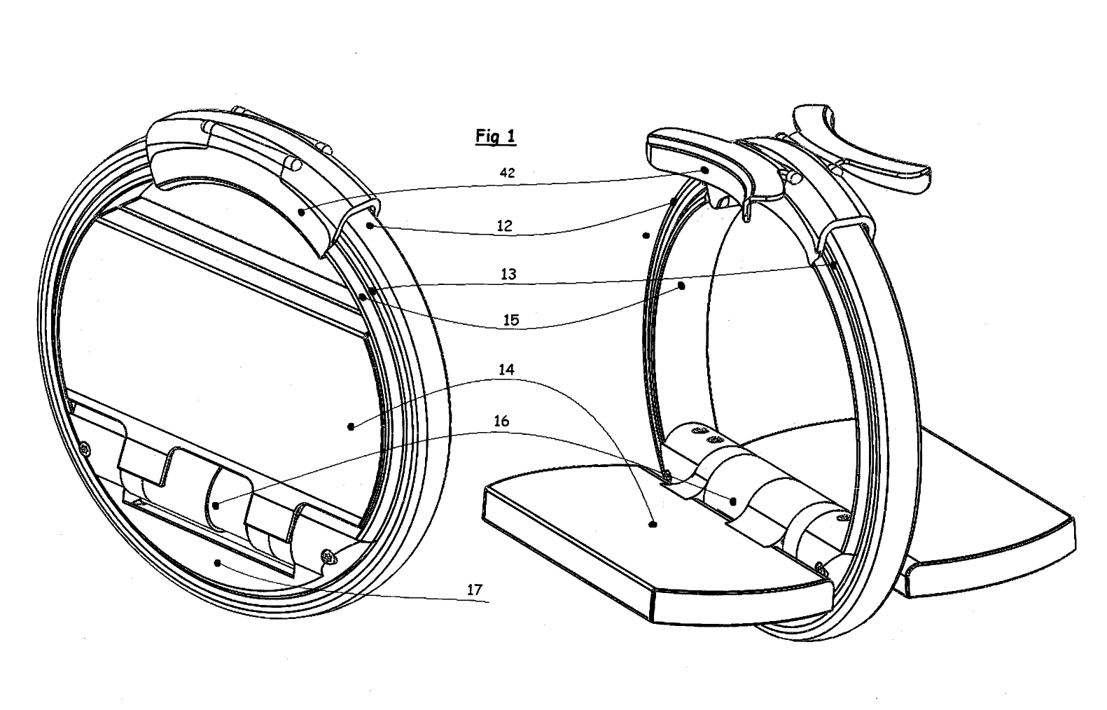

FIG. 1 represents the wheel when the footrests 14 and the guides 42 are unfolded in the right side and folded down in the left side.

The wheel includes a brushless motor, in a central casing 16 having the same level as the unfolded footrests, controlled by an electronic driver 17.

The inflated or plain tires 12, on the flexible ring 13 is guided by another ring 15 connected to the central casing of the motor 16 and to the guides 42 also used as a handle.

Preferably, the guide-handle 42 is surrounded by a soft and high friction material, avoiding the hand to glide for carrying.

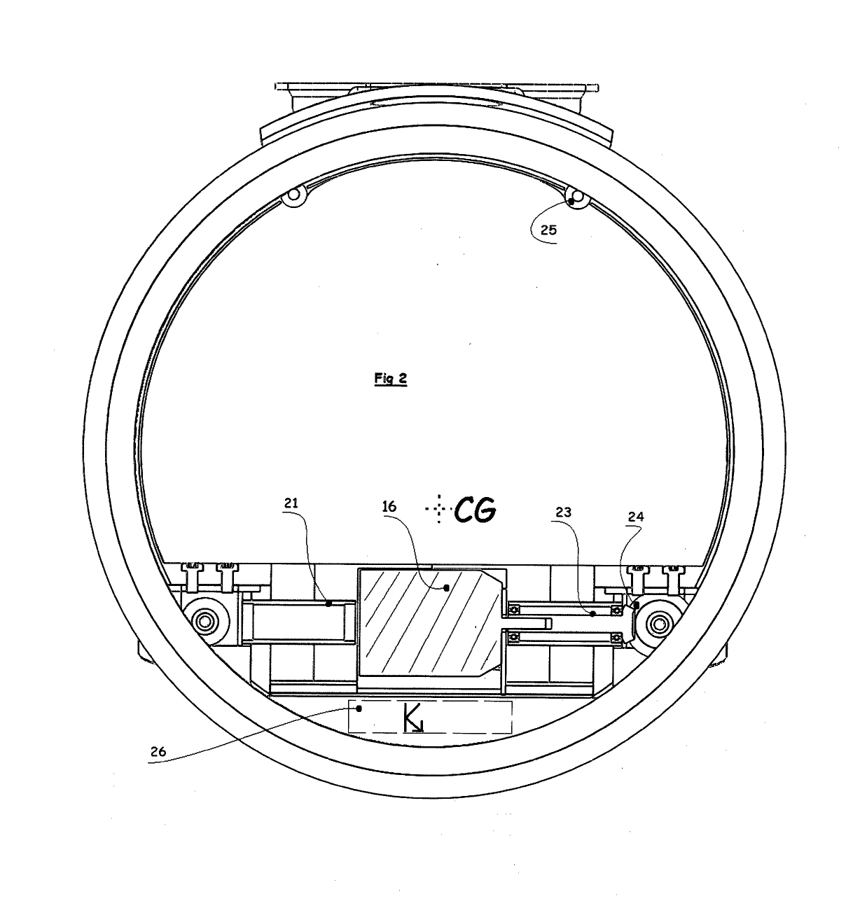

FIG. 2 illustrates the tubes 21, common axes of the 2 footrests 14, the brushless motor 16, controlled by its electronic controller 17 in its casing 26, and its axes 23 terminated by a 90° gear 24 turning one of the 4 rollers 25 guiding the wheel, and the Gravity Center under the lever of the center of the wheel.

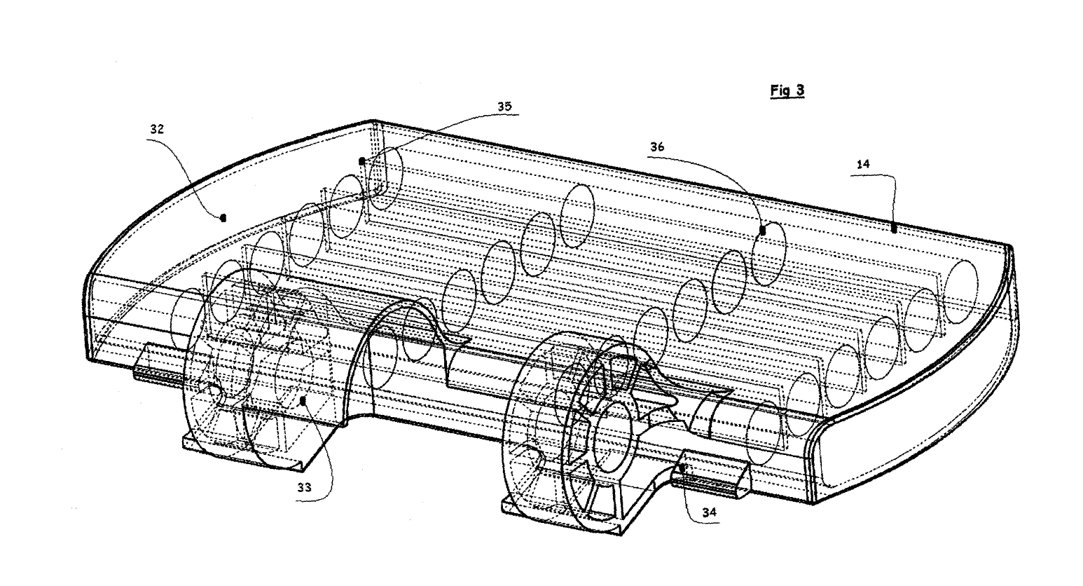

FIG. 3 illustrates the footrest 31 filled by rechargeable batteries 36 enclosed in a compartment sealed by covers 32 and separated by walls 35 for structural robustness, its tubular connection 33 with the tube 21 and the bumper 34 ensuring suspension and damping of the high frequency vibration by pressure on the casing 26.

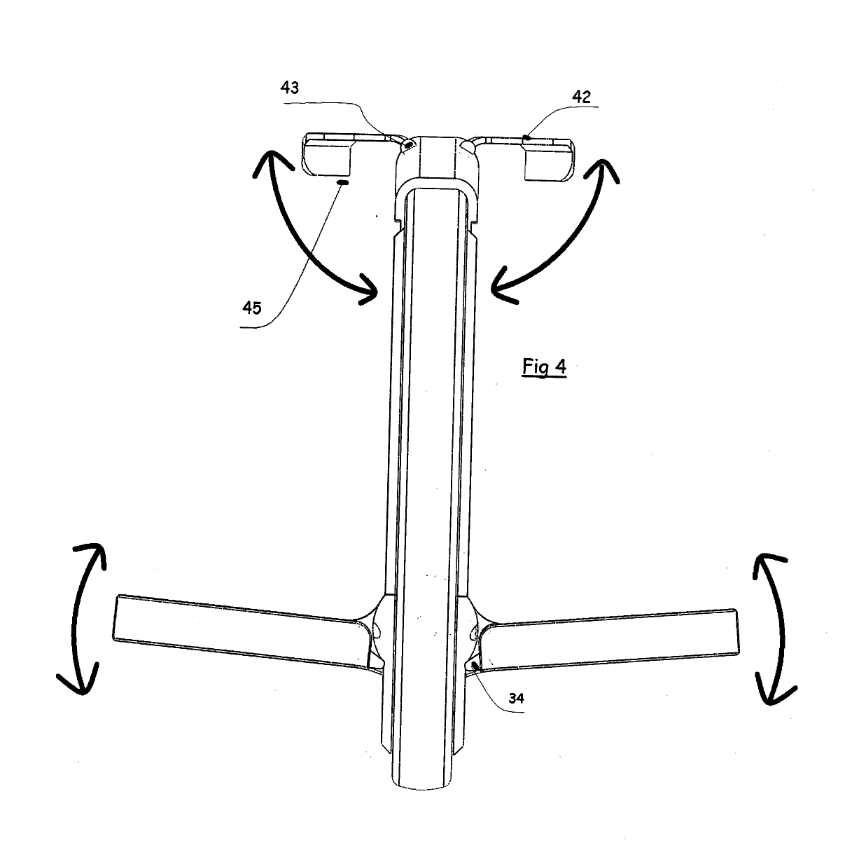

FIG. 4 illustrates again the action of the bumper 41 compressed by the footrests 14, the axis 43 of the guide 42 and its soft and frictional surface 45.

The heavy parts of the motorized wheel batteries, motors and structure are located under the feet during use, and contribute to the low position of the Gravity Center.

A bumper ensures some suspension of the footrests and damps the vibrations.

The ring wheel connected by roller to the structure may absorb vibrations thanks to its soft tire and by effect of an elastic deformation.

The encumbrance and the weight are minimized when folded because the thickness of the folded wheel is similar to the thickness of the tire and the thickness of the stack of 2 batteries and their casing.

The foldable guides are optional and the user may use the motorized unicycle with the guide 42 folded or with the guide unfolded.

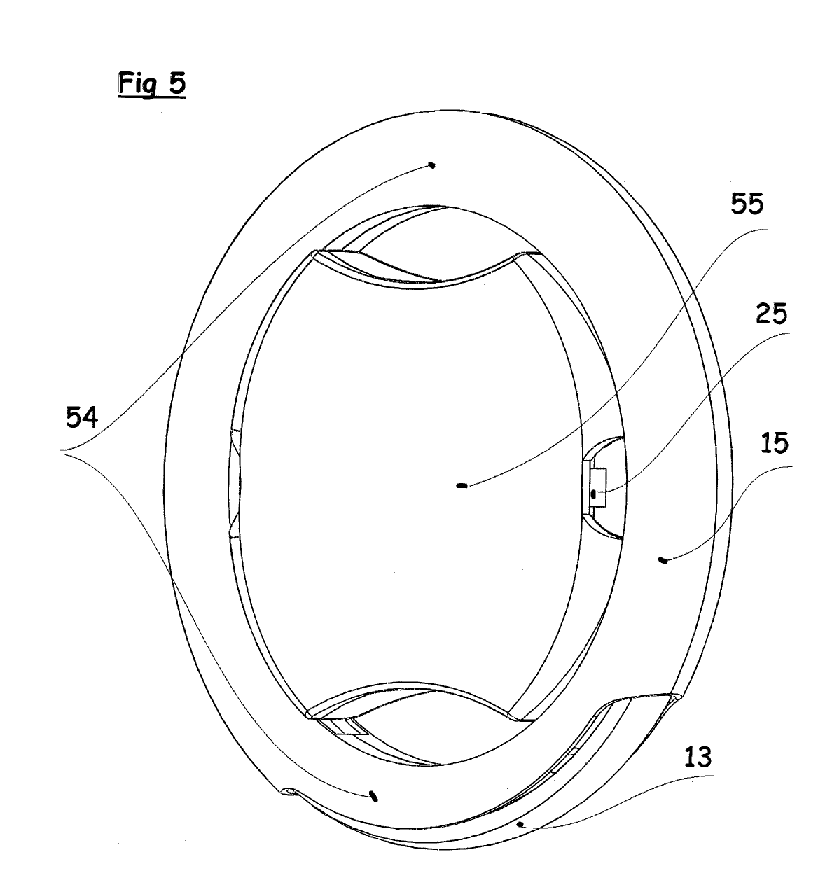

The FIG. 5 represents another embodiment of the invention having one only footrest 55 inserted in the center of the flexible wheel 13 and guide 15 for carrying.

According to a preferred embodiment of the invention this only footrest's 55 surface is made of a photoelectric material for a permanent recharge of the battery when exposed to the sun connected to battery via a step up voltage elevator according to the state of the art.

This guiding ring 15 has as first option, the shape of a tube enclosing the wheel for water protection need, and as another option the shape of a simple ring, both with guiding roller 25. It is catch as a handle 54 by the user and is surrounded by a soft material in option for a better grip of the hand not represented.

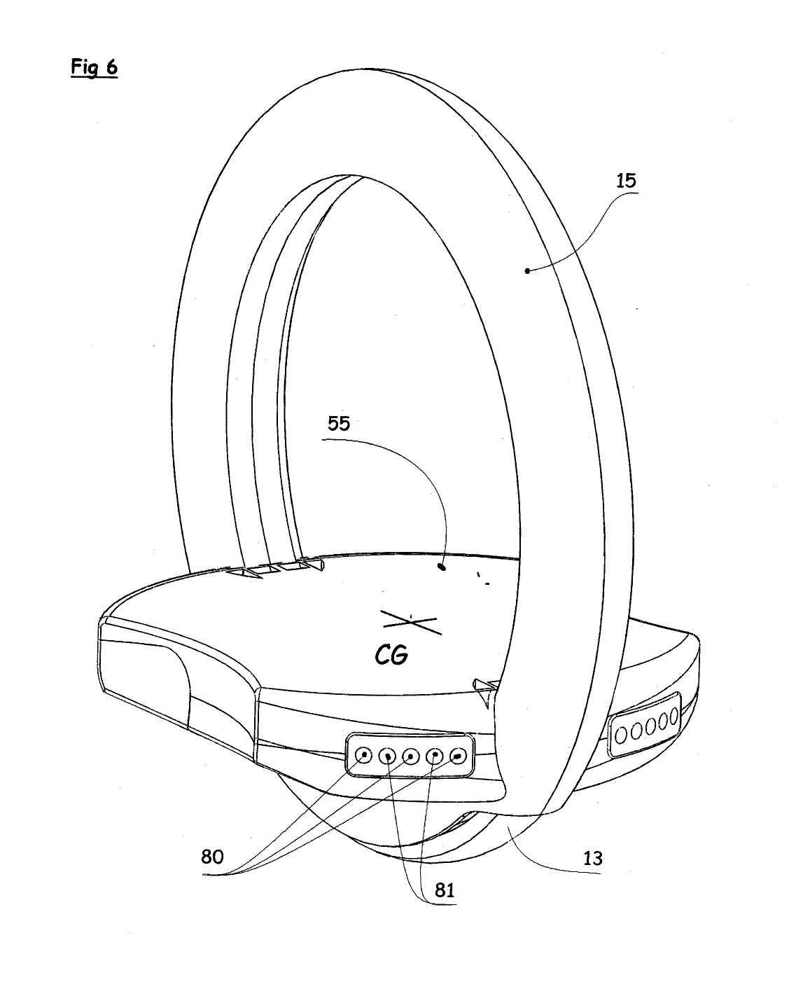

FIG. 6 represents the same footrest 55 inserted into the wheel 13 and guide 15 displaying a large stand, enough room for the ankles, a profile of the guide 15 tight enough so the user may keep the feet very close over the contact point on the floor, minimizing for each leg the lateral torque that the guide 15 could oppose when the user balances laterally. It represents also the gravity center CG lower than the wheel's axis and represents the lights 80 and the warnings 81. Such lights are preferably electroluminescent diodes. In such position the said footrest 55 covered by a photoelectric material in combination with a step up voltage elevator persists to charge the battery during use.

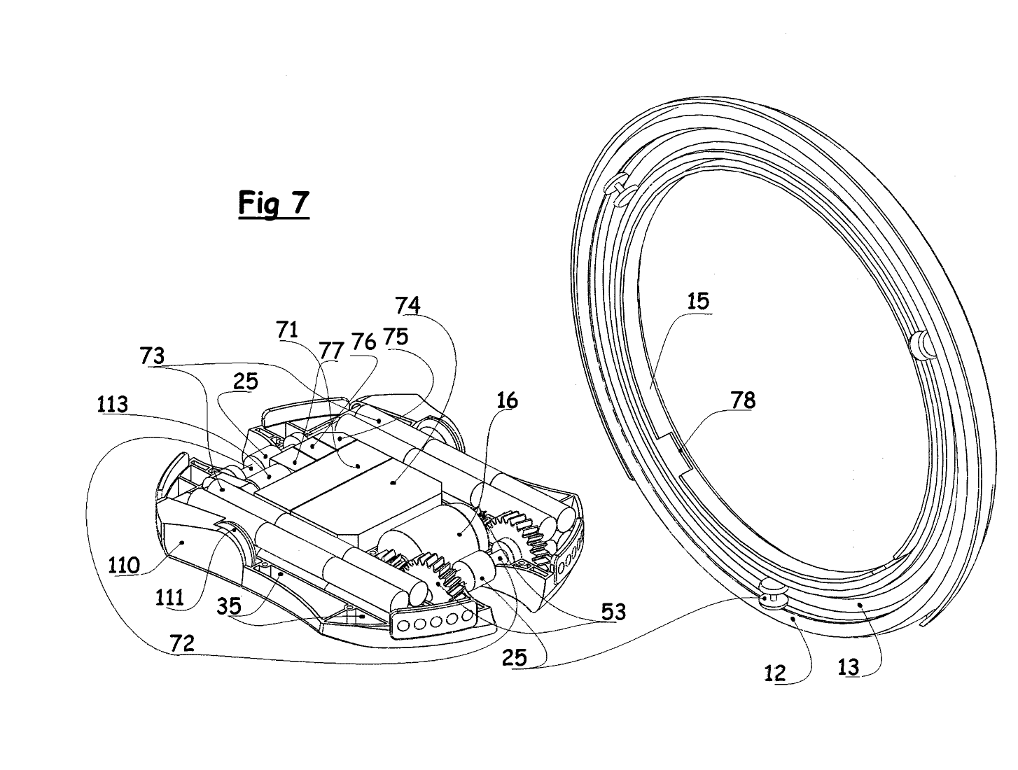

FIG. 7 represents the footrest 55 open beside the guide 15 open and displays several rollers 25, at least three for guiding the flexible wheel 13 inside the guide 15, and two embedded in the footrest rolling on the wheel's rim, when the footrest is inserted. The roller crosses a opening 78 open in the guide 15.

This footrest and the user are supported by the two rollers 25 rolling on the rim of the wheel 13, when the user stands on the footrest 55.

The guide 15 achieves also the function of a handle 54 when the footrest is horizontal, for carrying it unfolded or folded down, and it may be surrounded by a soft material for comfortable handling.

The footrest includes a transmission 53, a direct reducer by gear, able to transmit the motor's torque and speed to the rollers 25 when it is inserted. Optionally this transmission may be ensured by a belt.

According to the invention, it is provided a reduction of the motor's speed almost without lost with only 2 gears, when the brushless motor running at 8000 rpm, propels the wheel at a relatively low speed of 200 rpm corresponding at 14 km pro hour.

This high reduction ratio of 40 is the consequence of the roller rolling directly on the rim of the wheel 13 having an empty center.

This high reduction ratio allows operating a much faster motor than the torque motor currently used for electric scooter. Such high speed out runner brushless motor delivers a density of power 40 times higher, having as consequence that a motor of only 400 g delivers more power to the wheel 13 than a scooter's wheel of 8 kg powered by a torque motor directly connected between the rim and the fork.

The speed is controlled by an electronic system 71 managing also the unique or combined battery charge and discharge. The balance is controlled thanks to an internal longitudinal balance sensor serving the said electronic system 71 and optionally by a 2 axis longitudinal and lateral balance sensor 77. In this last option the lateral misbalance once detected by 71 cuts off the motor's power for the security reasons exposed earlier.

The combined batteries are for a non exclusive example a lithium ion polymer battery 74 able to a very high discharge rate, but an average energy storage, associated in parallel with a Lithium Nickel Manganese Cobalt battery 73 of the same voltage able to a very high energy storage at a reasonable cost but a low discharge rate.

The 75 loudspeaker and music player's volume is preferably controlled thanks to a speed controller 76 substantially in proportion to the speed.

The actuator 113 is driven by the said speed controller 76 and activated at a predetermined speed.

FIG. 8 represents the elastic deformation of the empty center wheel 13 made in a high flexibility material for example in polyamide.

According to the invention the rollers 25 guide the wheel 13 inside or around the guide 15, even when the said flexible wheel compressed. Those rollers 25 are made of a strong and resilient material for transferring the strength of the wheel to the guide's structure and for ensuring no direct friction between those 2 parts.

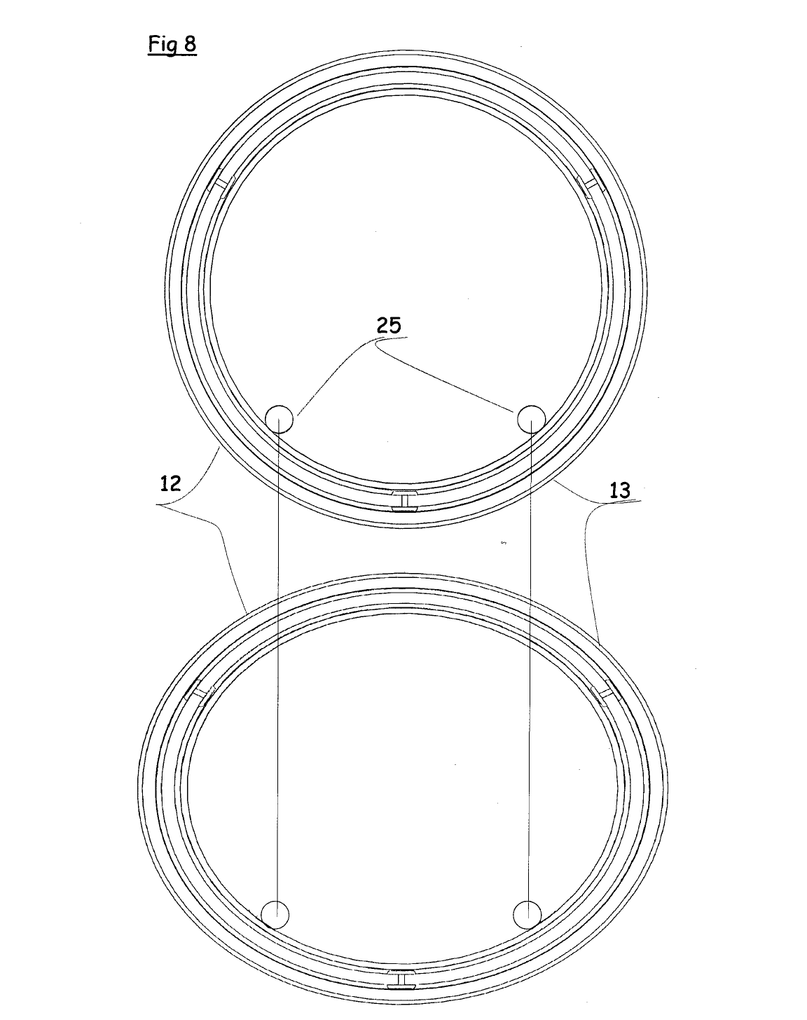

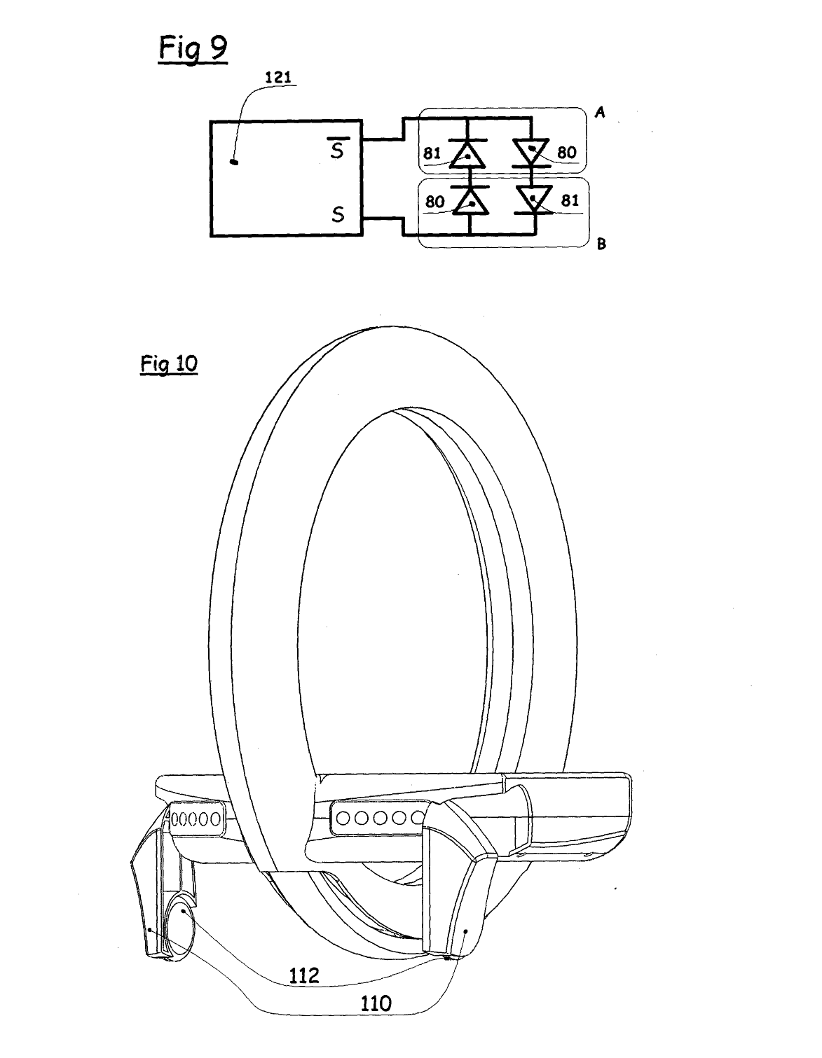

FIG. 9 describes an embodiment of the circuitry for lighting for example white 80 frontward and red 81 backward, when the user does not select a preferred side A or B of the wheel. The light sources are for example LEDs driven by the speed detector

According to the direction driven, the speed signal changes the polarity of the voltage, and induces a commutation of the diode's power and a commutation of the lighting color.

FIG. 10 is a back side view of the 2 lateral and retractable supports made of a lever 110 supporting a wheel 112 connected to a roller shaft 72. Optionally those supports are automatically unfolded at low speed of the unicycle under the control of the actuator 113 served by the speed controller 76.

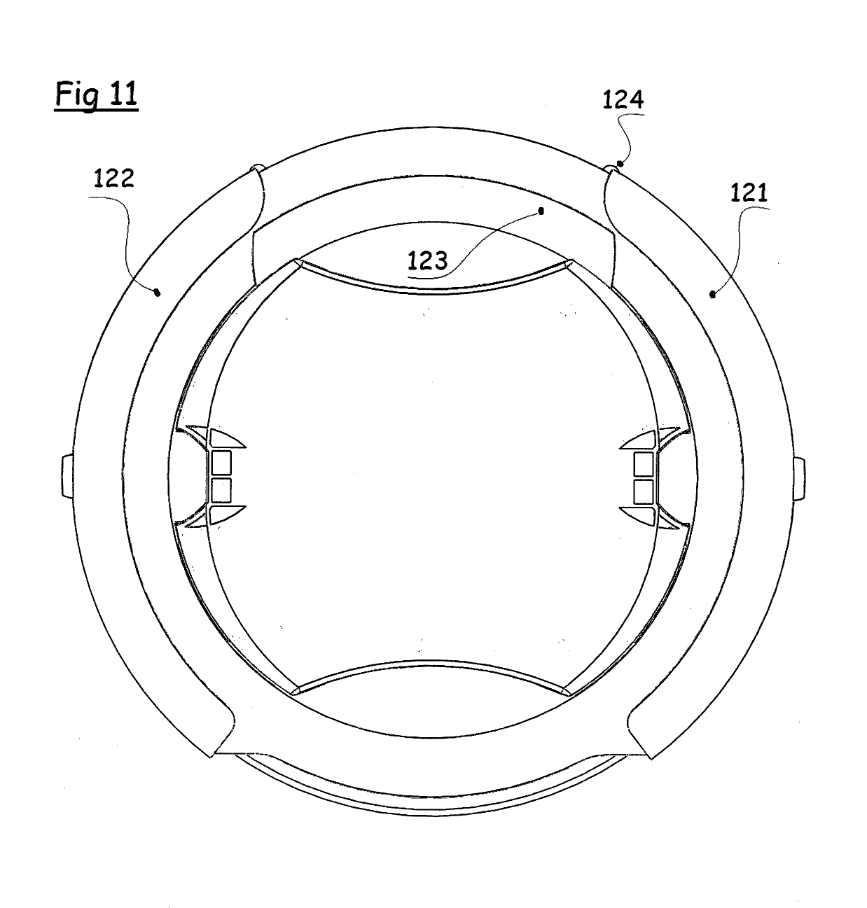

FIG. 11 represents movable parts 121, 122, 123, of the guide 15 folded down around the said guide.

FIG. 12 represents the same parts deployed such to realize a seat in which as a non limitative example 121 and 122 are connected to said guide 15 by hinges 124, and are realized in a robust and flexible material. 123 is an handle cover is a soft material clip on the guide 15, now used as a flexible seat when parts 121 and 122 are deployed and it is realized for example in a flexible silicon or polyurethane over wrapping a strong nylon tissue. 123 is clip on the extremities of 121 and 122 when it realizes the function of seat, and also clips on the guide 15 when it realizes the function of a soft handle.

FIG. 12 also represents at smaller scale this unicycle with foldable seat in static position, the lateral balance legs being unfolded down as lateral support ensuring a triangle of stability. This combination transforms automatically the said unstable unicycle rolling, into a stable seat when the speed decreases, allowing the user to step on and down in security and comfort.

Any rotation translation and assemblage of parts of an electric self balanced wheel may be operated for unfolding and strap a seat on it, the example exposed is not limitative of the preferred designs and realizes the invention becoming an electric self balanced unicycle.

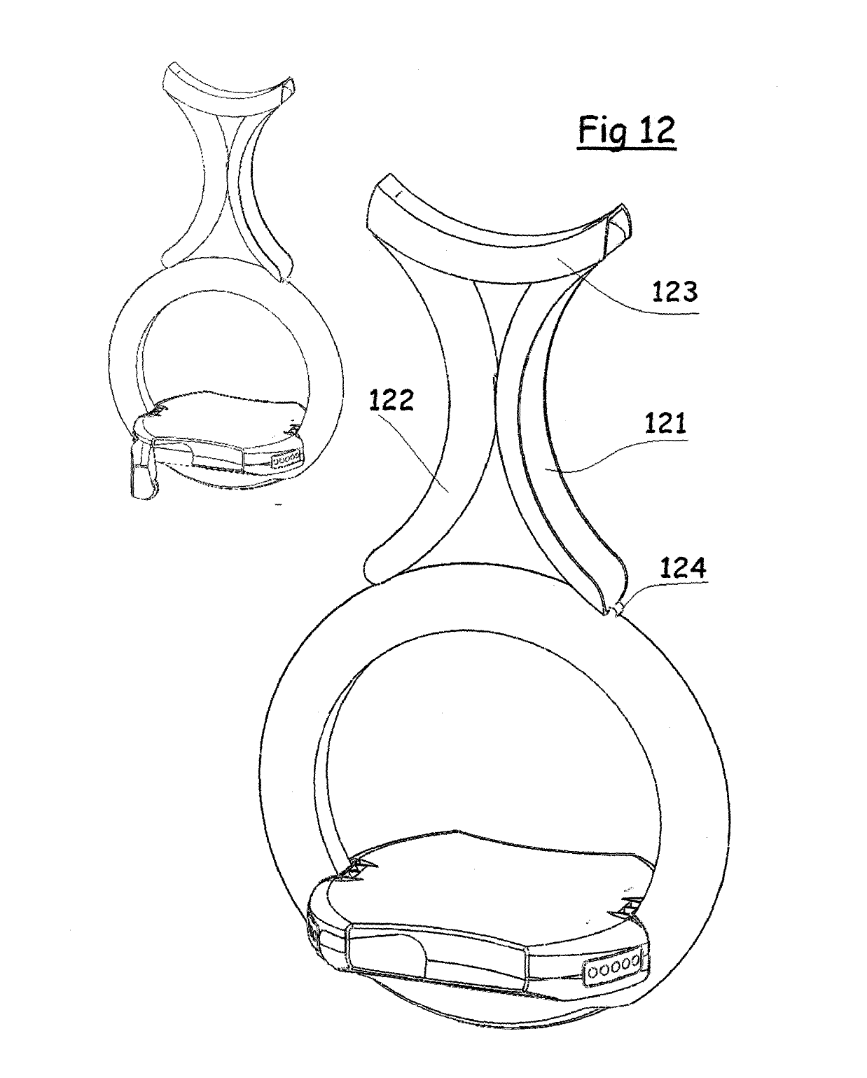

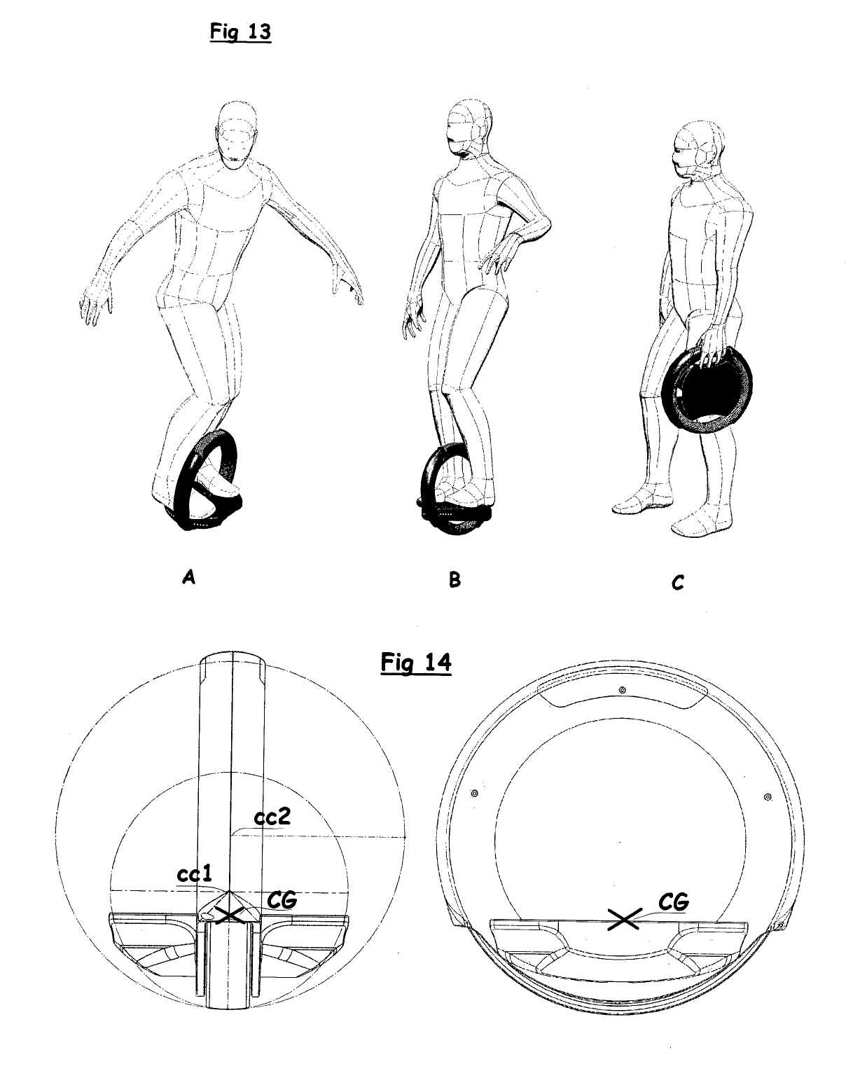

FIG. 13 illustrates the 3 main postures of the user, surfing A, riding frontward or backward B, carrying the wheel by hand C. Carrying the wheel in a bag is also recommended.

FIG. 14 illustrates lateral curvature center CC1 and the longitudinal curvature CC2 of the tire 12, and the gravity center CG. According to the invention le lateral curvature CC1 is located substantially over the gravity center CG and preferably under the longitudinal center of curvature CC2.

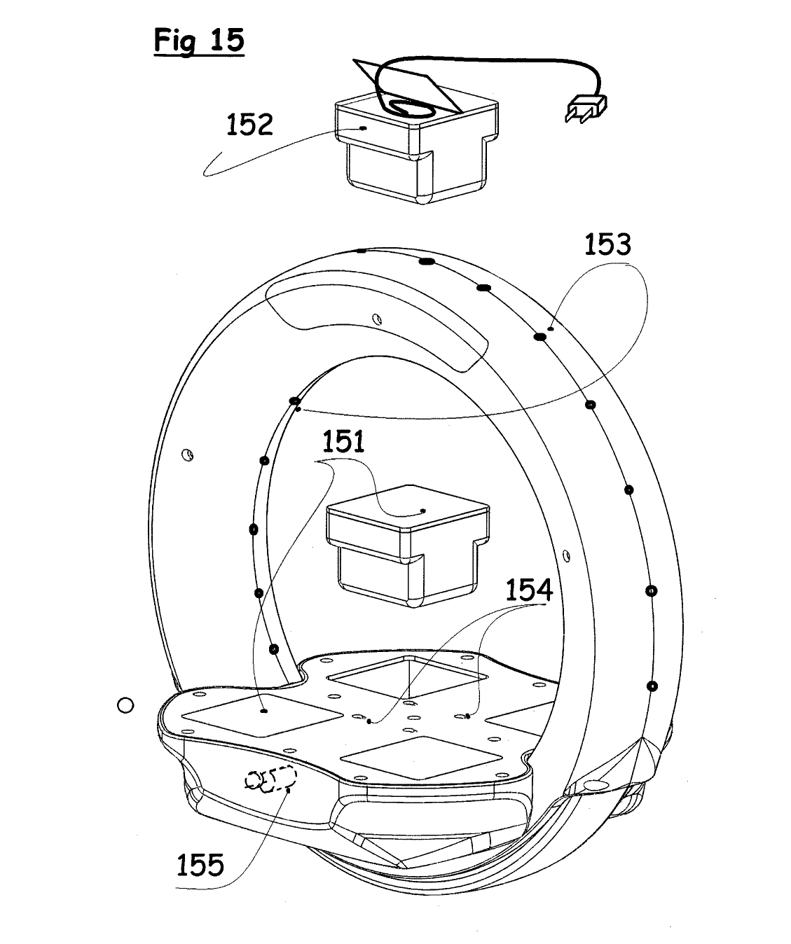

FIG. 15 illustrates several non limitative and non exclusives embodiments of the invention, with removable battery packs 151, a removable and optional domestic battery charger with a connection cable 152, for example a led strip lighting outside and inside the wheel's casing being translucent a combination of the 3 main colors RGB in order to display by an identified color the current range of speed of the balanced wheel; a mechanical and electrical connection 154 made of several connectors for powering and securing several optional devices, an internal vibration motor for warning the user.

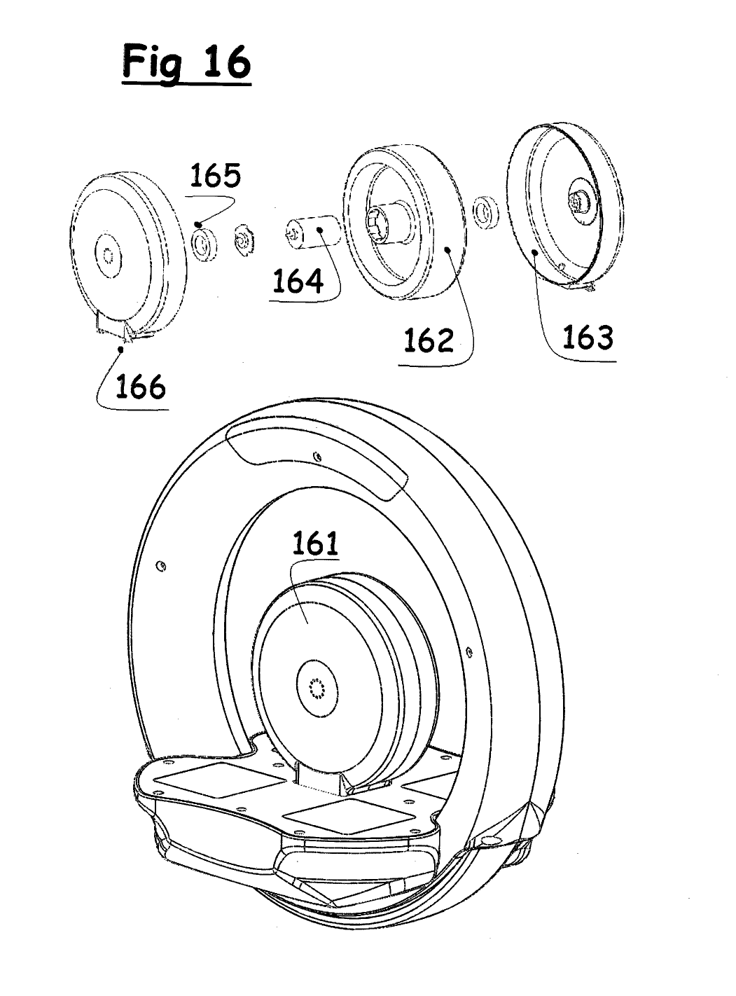

FIG. 16 illustrates a non exclusive embodiment of the combination of a removable Gyroscope 161 with the balanced wheel for regulating the precession level according to the wheels speed, by rotating the flywheel 162 in the same direction as the balanced wheel when slow, and opposite direction when the balanced wheel is fast, thanks to a motor 164, torque transfer bearings 165, a robust casing 163, and robust connections 166. According to the invention a direct current source embedded inside in the unique footrest 55 powers the said motor 164 with a polarity according to the wheel's speed.

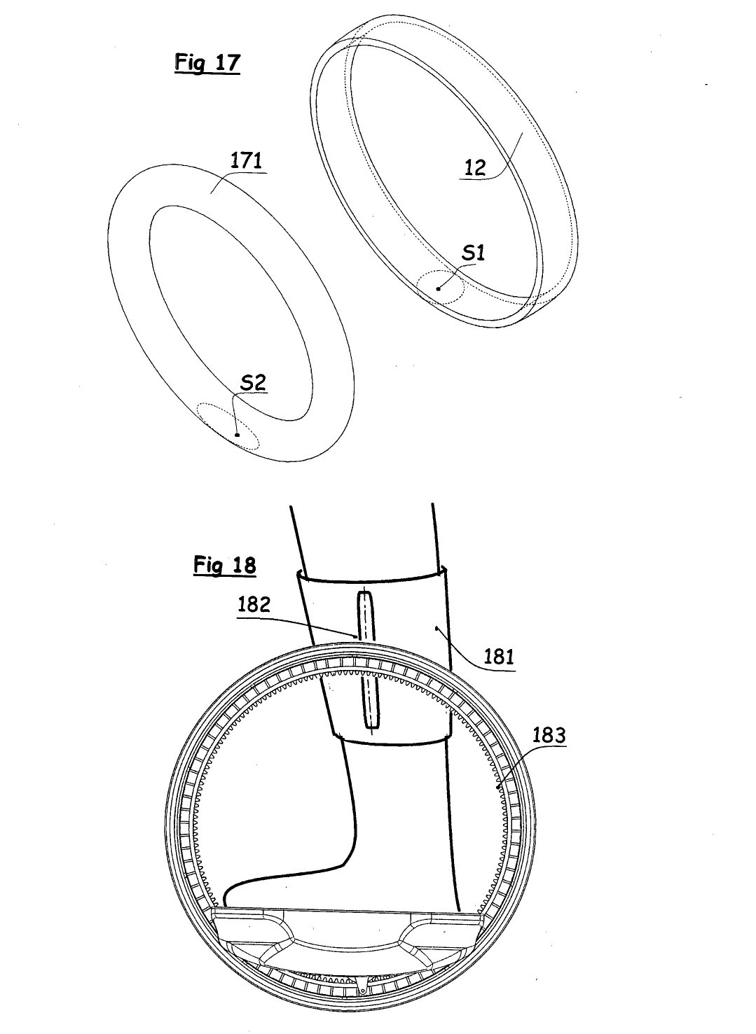

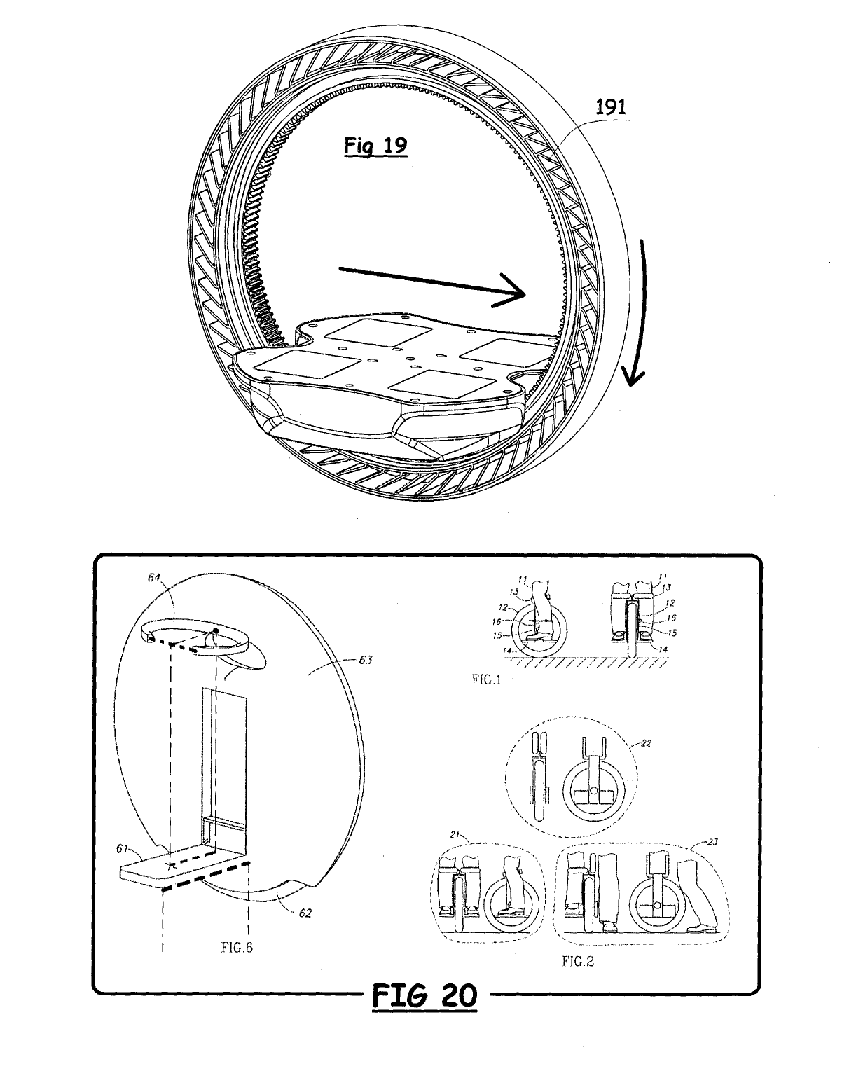

FIG. 17 illustrates the difference between an inflated tire having necessarily a short lateral curvature radius, and a long interface with the floor with the compact circular interface of the airless lire having a long lateral curvature radius. This illustration exposes that a circular interface with the floor oppose less frictional torque than a long interface of an inflated tire to the orientation of the wheel and facilitates the small adjustments requested by the balance at low speed.

FIG. 18 exposes a balanced wheel without wheel's casing, a rim with gear 183 and its tire 12 is supported by a leg protection 181 when the user climbs on it and transfers to the wheel a lateral torque and stress, this leg protection secured like a sock according to the state of the art is manufactured either in a very low friction material for example like PTFE, or includes a roller 182 of substantially vertical axis.

FIG. 19 exposes a rim dedicated to a competition version of the balanced wheel able to absorb high impacts and overpass significant obstacles thanks to spiral oriented spokes 191 acting like suspension, damper and pole vaulting levers if the wheel is traveling from left to right and passes over obstacles.

The invention has been described as a

Seat-less electric self-balanced wheel having
at least one rechargeable battery pack,
at least one electric motor,
at least one electronic balance control system,
at least one lateral support of one user's leg,
at least one wheel's casing

wherein it includes:
only one wheel, said wheel is hub-less,
at least one power transmission between said motor and the said wheel,
At least one foot-rest where the footrest or combined footrests size are up to the diameter of the wheel casing
said footrest is a container
said foot-rest is configured to support one or two feet of the user standing with both legs on the same side of the wheel or with one leg on either side of the wheel when it is located bellow the center of the wheel
a placement of the center of gravity substantially below the center of said hub-less wheel due to the placement of its heavy components such to include inside the said footrest container the batteries and-or motor and-or transmission and-or balance system

in respect with the ground clearance and with optimized static, dynamic, longitudinal, and lateral stability with safety and ergonomic design.

wherein said foot-rest may be located in the empty center of the wheel during transportation and storage.

wherein said foot-rest and said wheel may be separated parts.

wherein the said wheel may include a flexible rim.

wherein the said wheel may be guided by at least 3 rollers rolling on said rim with their axis connected to said wheel's casing.

wherein said transmission may include a rotational speed reducer transmitting the motor's power to the rim.

wherein at least 2 rollers connected to at least one foot rest may roll on said rim.

wherein at least one roller may be driven by the said motor.

wherein the said rim may include leaning spokes.

wherein a high density power battery may cooperate with a high density energy battery.

wherein a soft material may cover the wheel's casing.

wherein it may stand on the floor before and after use thanks to a lateral center of curvature of the tire located significantly higher than its center of gravity.

wherein its foot-rest surface may be a photoelectric charger of battery.

wherein one light may illuminate the way frontward thanks to said balance sensor detecting the direction combined with at least 2 light sources driven by the electronic balance sensor.

wherein 2 additional supports on the ground may be located backward on both sides being retractable by a rotation around one axis automatically deployed or retracted by an actuator driven by a speed sensor.

wherein foldable and un-foldable parts of the structure may support and become a seat when unfolded.

wherein it may be dynamically stable laterally in combination with a flywheel, an electric motor, removable mechanical and electric connections between the said electric balanced wheel and said motor and housing, said flywheel turning in the same direction as the wheel when slow, and in an opposite direction when the balanced wheel is fast.

wherein it may include no wheel's casing in combination with at least one lateral leg supports and protection.

wherein it may include a vibration generator motor mechanically secured to one foot-rest or vibration generated with the primary drive motor.

wherein it may include at least two similar removable battery packs and at least two similar placements for those batteries pack.

an electric vehicle wherein it may include at least 2 similar placements for battery packs, one battery pack inserted in one placement and one charger with a connection to the domestic power network inserted in the second placement.

an electric vehicle wherein its current speed range may be displayed thanks to a color of illumination or a color of its casing resulting from the combination of a speed detector and comparator included in the electronic balance system, at multiple colored light sources connected to said electronic, and with several transparent or translucent parts of its casing.

While the preferred embodiment of the invention have been illustrated and described, as noted above, many changes can be made without departing from the spirit and scope of the invention. Accordingly, the scope of the invention is not limited by the disclosure of the preferred embodiment and any combination of the ensegnements of the description enters into it scope.

Instead, the invention should be determined entirely by reference to the following claims:

1) A seat-less electric self-balanced wheel having
at least one rechargeable battery pack,
at least one electric motor,
at least one electronic balance control system,
at least one lateral support of one user's leg,
at least one wheel's casing
wherein it includes:
only one wheel, said wheel is hub-less,
at least one power transmission between said motor and the said hub-less wheel
at least one foot-rest where the footrest or combined footrests size are up to the diameter of the wheel casing
said footrest is a container
said foot-rest configured to support one or two feet of the user standing with both legs on the same side of the wheel or with one leg on either side of the wheel when it is located bellow the center of the wheel
a placement of the center of gravity substantially below the center of said hub-less wheel due to the placement of its heavy components such to include inside the said footrest container the batteries and-or motor and-or transmission and-or balance system
in respect with the ground clearance and with optimized static, dynamic, longitudinal, and lateral stability with security and ergonomic design.

2) Electric Self Balanced wheel according to claim 1
wherein said foot-rest is located in the empty center of the wheel during transportation and storage.

3) Electric self balanced wheel according to claim 2 wherein said foot-rest and said wheel are separated parts.

4) Electric Self Balanced wheel according to claim 1
wherein the said wheel includes a flexible rim.

5) Electric self balanced wheel according to claim 4 wherein the said wheel is guided by at least 3 rollers rolling on said rim with their axis connected to said wheel's casing.

6) Electric Self Balanced wheel according to claim 1
wherein said transmission includes a rotational speed reducer transmitting the motor's power to the rim.

7) Electric Self Balanced wheel according to claim 4 wherein at least 2 rollers connected to at least one foot rest roll on said rim.

8) Electric Self Balanced wheel according to claim 7 wherein at least one roller is driven by the said motor.

9) Electric Self Balanced wheel according to claim 4 wherein the said rim includes leaning spokes.

10) Electric Self Balanced wheel according to claim 1 wherein a high density power battery cooperates with a high density energy battery.

11) Electric Self Balanced wheel according to claim 1 wherein a soft material covers the wheel's casing.

12) Electric Self Balanced wheel according to claim 1 wherein it stands on the floor before and after use thanks to a lateral center of curvature of the tire located significantly higher than its center of gravity.

13) Electric Self Balanced wheel according to claim 1 wherein its foot-rest surface is a photoelectric charger of battery.

14) Electric Self Balanced wheel according to claim 1 wherein one light illuminates the way frontward thanks to said balance sensor detecting the direction combined with at least 2 light sources driven by the electronic balance sensor.

15) Electric Self Balanced wheel according to claim 1 wherein 2 additional supports on the ground are located backward on both sides being retractable by a rotation around one axis automatically deployed or retracted by an actuator driven by a speed sensor.

16) Electric Self Balanced wheel according to claim 1 wherein foldable and un-foldable parts of the structure support and become a seat when unfolded.

17) Electric Self Balanced wheel according to claim 1 wherein it is dynamically stable laterally in combination with a flywheel, an electric motor, removable mechanical and electric connections between the said electric balanced wheel and said motor and housing, said flywheel turning in the same direction as the wheel when slow, and in an opposite direction when the balanced wheel is fast.

18) Electric Self Balanced wheel according to claim 1 wherein it includes no wheel's casing in combination with at least one lateral leg supports and protection.

19) Electric Self Balanced wheel according to claim 1 wherein it includes a vibration generator motor mechanically secured to one foot-rest.

20) Electric Self Balanced wheel according to claim 1 wherein it includes at least two similar removable battery packs and at least two similar placements for those batteries pack.

21) Electric Self Balanced wheel according to claim 1 wherein it includes at least 2 similar placements for battery packs, one battery pack inserted in one placement and one charger with a connection to the domestic power network inserted in the second placement.

22) Electric Self Balanced wheel according to claim 1 wherein its current speed range is displayed thanks to a color of illumination or a color of its casing resulting from the combination of a speed detector and comparator included in the electronic balance system, at least 3 colored light sources connected to said electronic, and/or several transparent or translucent parts of its casing.

23) Electric Self Balanced wheel according to claim 5
wherein said transmission includes a rotational speed reducer transmitting the motor's power to the rim.
